(19) United States
(12) Patent Application Publication
(10) Pub. No.: US 2023/0189122 A1
(43) Pub. Date: Jun. 15, 2023

(54) ADMISSION CONTROL BASED ON NETWORK ENERGY SAVING

(71) Applicant: QUALCOMM Incorporated, San Diego, CA (US)

(72) Inventors: Naeem AKL, Somerville, NJ (US); Navid ABEDINI, Basking Ridge, NJ (US); Jianghong LUO, Skillman, NJ (US); Tao LUO, San Diego, CA (US); Karl Georg HAMPEL, Jersey City, NJ (US); Junyi LI, Fairless Hills, PA (US)

(21) Appl. No.: 17/644,524

(22) Filed: Dec. 15, 2021

(51) Int. Cl. H04W 48/06; H04L 47/70

(52) U.S. Cl. CPC H04W 48/06; H04L 47/70

(57) ABSTRACT

Aspects presented herein may enable a CU to receive type(s) of request(s) a DU is capable of admitting, such that the CU may transmit request(s) to the DU based on the type(s) of request(s) supported by the DU to improve network resource utilization. In one aspect, a CU receives, from a DU of the wireless network, an indication of one or more types of resources for which the DU supports admission. The CU transmits, to the DU, a request for the admission of at least one resource in response to the at least one resource having a type included in the one or more types of resources indicated by the DU.

### TECHNICAL FIELD

The present disclosure relates generally to communication systems, and more particularly, to an admission control between a central unit (CU) and a distributed unit (DU).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus receives, from a distributed unit (DU) of the wireless network, an indication of one or more types of resources for which the DU supports admission. The apparatus transmits, to the DU, a request for the admission of at least one resource in response to the at least one resource having a type included in the one or more types of resources indicated by the DU.

In another aspect of the disclosure, a method, a computer-readable medium, and an apparatus are provided. The apparatus transmits, to a central unit (CU) of the wireless network, an indication of one or more types of resources for which the DU supports admission. The apparatus receives, from the CU, a request for the admission of at least one resource having a type included in the one or more types of resources indicated to the CU.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of an integrated access and backhaul (IAB) network in accordance with various aspects of the present disclosure.

FIG. 5 is a diagram illustrating an example of an IAB network and components thereof in accordance with various aspects of the present disclosure.

FIG. 6 illustrates examples of interaction between an IAB donor, an IAB node, and a child IAB node in accordance with various aspects of the present disclosure.

FIG. 7 is a diagram illustrating an example of an intra-CU admission in accordance with various aspects of the present disclosure.

FIG. 8 is a diagram illustrating an example of an inter-CU admission in accordance with various aspects of the present disclosure.

FIG. 9 is a communication flow illustrating an example of a distributed unit (DU) indicating to a central unit (CU) type(s) of resource(s) for which the DU supports admission in accordance with various aspects of the present disclosure.

FIG. 10 is a flowchart of a method of wireless communication in accordance with various aspects of the present disclosure.

FIG. 11 is a flowchart of a method of wireless communication in accordance with various aspects of the present disclosure.

FIG. 12 is a diagram illustrating an example of a hardware implementation for an example apparatus in accordance with various aspects of the present disclosure.

FIG. 13 is a flowchart of a method of wireless communication in accordance with various aspects of the present disclosure.

FIG. 14 is a diagram illustrating an example of a hardware implementation for an example apparatus in accordance with various aspects of the present disclosure.

### DETAILED DESCRIPTION

Aspects presented herein may improve the performance and the latency of communication in a network by reducing or preventing a network entity (e.g., a CU) from requesting one or more services that are not supported by another network entity (e.g., a DU), such that the number of rejections for service requests between network entities may be reduced to improve network resource utilizations. For example, aspects presented herein may enable a first network entity (e.g., a DU) to proactively indicate, to a second network entity (e.g., a CU), the general type(s) of request(s) the first network entity is capable of or willing to admit, which may be based on the first network entity's energy saving mode. In response, the second network entity may take the general type(s) of request(s) the first network entity is capable of or willing to admit into account when the second network entity is transmitting service request(s) to the first network entity. In some examples, the general type of request(s) the first network entity is capable of or willing to admit may include the type of device(s) (e.g., UE, IAB-node, repeaters, etc.), device/child capability, traffic type (e.g., GBR, non-GBR), and/or traffic QoS, etc.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Aspects described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described aspects may occur. Implementations may range a spectrum from chip-level or modular components to non-modular, non-chip-level implementations and further to aggregate, distributed, or original equipment manufacturer (OEM) devices or systems incorporating one or more aspects of the described aspects. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, aggregated or disaggregated components, end-user devices, etc. of varying sizes, shapes, and constitution.

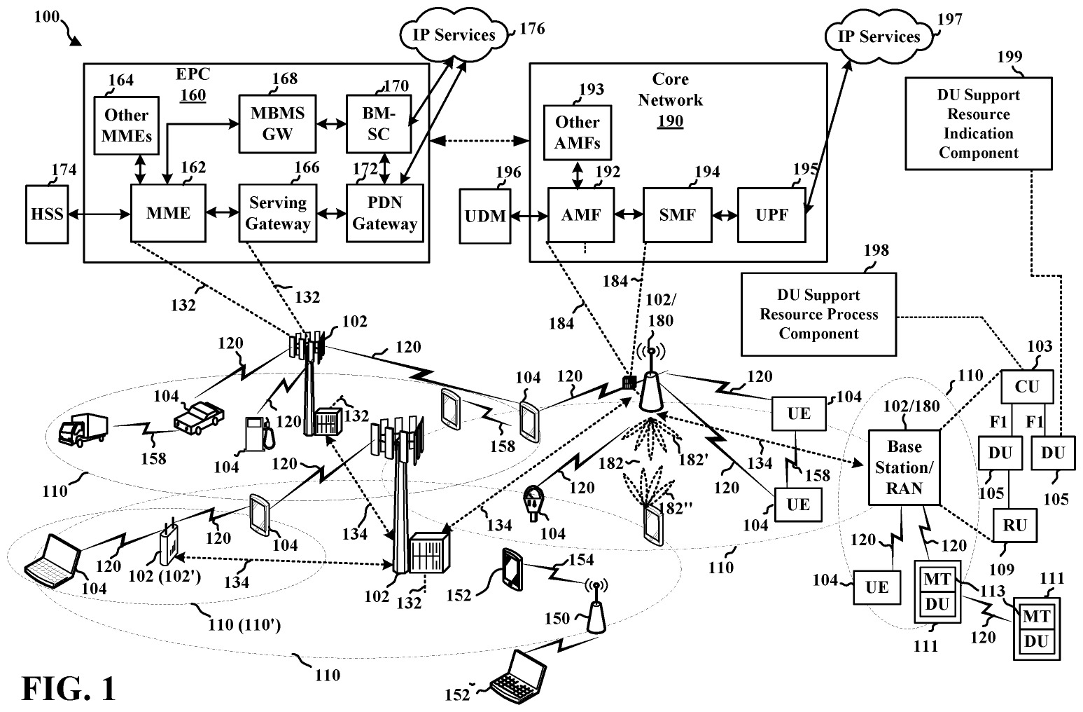

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

In certain aspects, a CU 103, which may be part of a base station 102/180, may include a DU support resource process component 198 configured to receive type(s) of request(s) a DU is capable of admitting, such that the CU 103 may transmit request(s) to the DU based on the type(s) of request(s) supported by the DU to improve network resource utilization. In one configuration, the DU support resource process component 198 may be configured to receive, from a DU of the wireless network, an indication of one or more types of resources for which the DU supports admission. In such configuration, the DU support resource process component 198 may transmit, to the DU, a request for the admission of at least one resource in response to the at least one resource having a type included in the one or more types of resources indicated by the DU.

In certain aspects, a DU 105, which may be part of a base station 102/180, may include a DU support resource indication component 199 configured to indicate type(s) of request(s) a DU is capable of admitting to a CU, such that the CU may transmit request(s) to the DU 105 based on the type(s) of request(s) supported by the DU 105 to improve network resource utilization. In one configuration, the DU support resource indication component 199 may be configured to transmit, to a CU of the wireless network, an indication of one or more types of resources for which the DU supports admission. In such configuration, the DU support resource indication component 199 may receive, from the CU, a request for the admission of at least one resource having a type included in the one or more types of resources indicated to the CU.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

In some aspects, a base station 102 or 180 may be referred as a RAN and may include aggregated or disaggregated components. As an example of a disaggregated RAN, a base station may include a central unit (CU) 103, one or more distributed units (DU) 105, and/or one or more remote units (RU) 109, as illustrated in FIG. 1. A RAN may be disaggregated with a split between an RU 109 and an aggregated CU/DU. A RAN may be disaggregated with a split between the CU 103, the DU 105, and the RU 109. A RAN may be disaggregated with a split between the CU 103 and an aggregated DU/RU. The CU 103 and the one or more DUs 105 may be connected via an F1 interface. A DU 105 and an RU 109 may be connected via a fronthaul interface. A connection between the CU 103 and a DU 105 may be referred to as a midhaul, and a connection between a DU 105 and an RU 109 may be referred to as a fronthaul. The connection between the CU 103 and the core network may be referred to as the backhaul. The RAN may be based on a functional split between various components of the RAN, e.g., between the CU 103, the DU 105, or the RU 109. The CU may be configured to perform one or more aspects of a wireless communication protocol, e.g., handling one or more layers of a protocol stack, and the DU(s) may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. A CU 103 may host higher layer functions, e.g., above the RLC layer, such as a service data adaptation protocol (SDAP) layer, a packet data convergence protocol (PDCP) layer. In other implementations, the split between the layer functions provided by the CU, DU, or RU may be different.

An access network may include one or more integrated access and backhaul (IAB) nodes 111 that exchange wireless communication with a UE 104 or other IAB node 111 to provide access and backhaul to a core network. In an IAB network of multiple IAB nodes, an anchor node may be referred to as an IAB donor. The IAB donor may be a base station 102 or 180 that provides access to a core network 190 or EPC 160 and/or control to one or more IAB nodes 111. The IAB donor may include a CU 103 and a DU 105. IAB nodes 111 may include a DU 105 and a mobile termination (MT) 113. The DU 105 of an IAB node 111 may operate as a parent node, and the MT 113 may operate as a child node.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

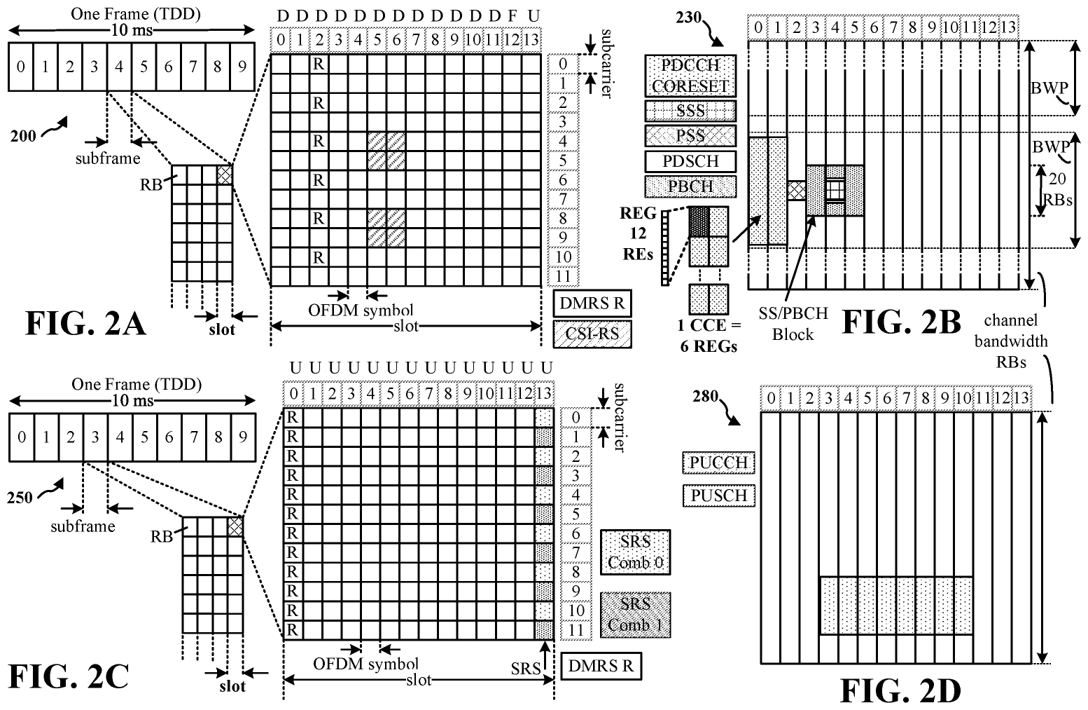

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

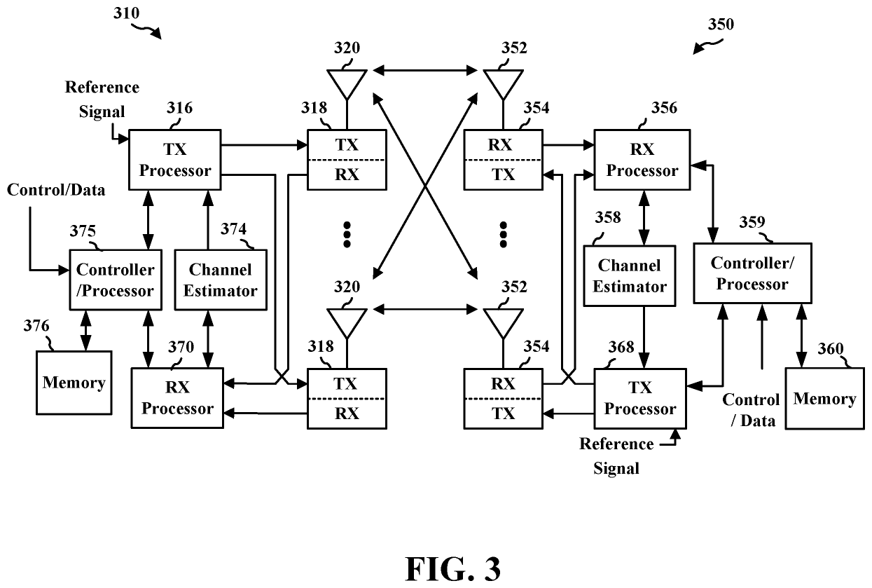

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 316, the RX processor 370, and the controller/processor 375 may be configured to perform aspects in connection with the DU support resource process component 198 and/or the DU support resource indication component 199 of FIG. 1.

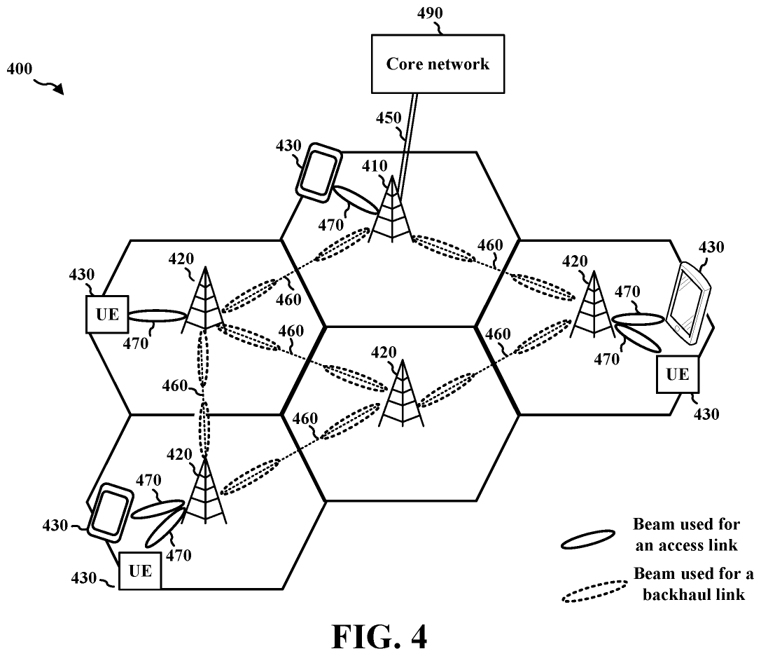

FIG. 4 is a diagram illustrating an integrated access and backhaul (IAB) network 400 in accordance with various aspects of the present disclosure. The IAB network 400 may include an anchor node (which may be referred to herein as an “IAB donor” 410) and access nodes (which may be referred to herein as “IAB nodes” 420). The IAB donor 410 may be a base station, such as a base station 102 or 180 described in connection with FIG. 1, and may perform functions to control the IAB network 400. The IAB donor 410 may provide a wireline connection to a core network 490. The IAB nodes 420 may include L2 relay nodes that relay traffic between the IAB donor 410 and other IAB nodes or UEs. Together, the IAB donor 410 and the IAB nodes 420 may share resources to provide an access network and a backhaul network to the core network 490. For example, resources may be shared between access links and backhaul links in the IAB network.

One or more UEs 430 may interface with the IAB nodes 420 or the IAB donor 410 through access links 470. The IAB nodes 420 communicate with each other and with the IAB donor 410 through backhaul links 460. The IAB donor 410 is connected to the core network 490 via a wireline backhaul link 450. The UEs 430 may communicate with the core network 490 by relaying messages through their respective access link 470 to the IAB network 400, which then may relay the message through backhaul links 460 to the IAB donor 410 to communicate to the core network 490 through the wireline backhaul link 450. Similarly, the core network may communicate with a UE 430 by sending a message to the IAB donor 410 through the wireline backhaul link 450. The IAB donor 410 sends the message through the IAB network 400 via backhaul links 460 to the IAB node 420 connected to the one or more UEs 430, and the IAB node 420 sends the message to the one or more UEs 430 via the access link 470.

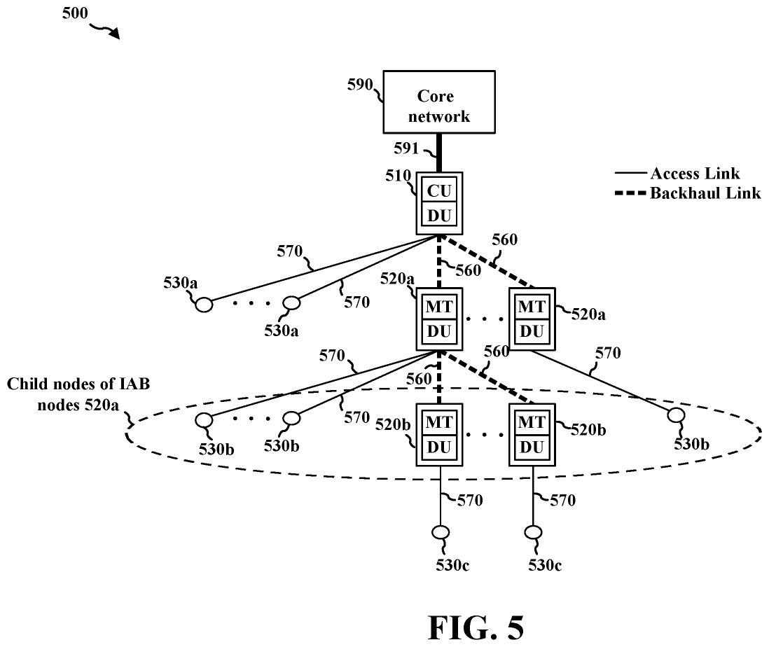

FIG. 5 is a diagram illustrating another example of an IAB network 500 and components thereof in accordance with various aspects of the present disclosure. The IAB network 500 includes an IAB donor 510 and IAB nodes 520a and 520b. The IAB nodes 520a and 520b, as well as the IAB donor 510, may provide wireless access links 570 to UEs 530a and 530b, respectively.

The IAB donor 510 may be considered a root node of the tree structure of the IAB network 500. The IAB donor node 510 may be connected to the core network 590 via a wired connection 591. The wired connection may include, e.g., a wireline fiber. For example, the IAB donor node 510 may provide a connection to one or more IAB nodes 520a. The IAB nodes 520a may each be referred to as a child node of the IAB donor node 510. The IAB donor node 510 may also provide a connection to one or more UE 530a, which may be referred to as a child UE of the IAB donor 510. The IAB donor 510 may be connected to its child IAB nodes 520a via backhaul links 560, and may be connected to the child UEs 530a via access links 570. The IAB nodes 520a that are children nodes of IAB node 510 may also have IAB node(s) 520b and/or UE(s) 530b as children. For example, IAB nodes 520b may further connect to child nodes and/or child UEs. FIG. 5 illustrates IAB nodes 520b providing an access link to UEs 530c, respectively.

The IAB donor 510 may include a central unit (CU) and a distributed unit (DU). The central unit CU may provide control for the IAB nodes 520a, 520b in the IAB network 500. For example, the CU may be responsible for configuration of the IAB network 500. The CU may perform RRC/PDCP layer functions. The DU may perform scheduling. For example, the DU may schedule resources for communication by the child IAB nodes 520a and/or UEs 530a of the IAB donor 510.

The IAB nodes 520a, 520b may include a mobile termination (MT) and a DU. The MT of IAB node 520a may operate as a scheduled node, scheduled similar to a UE 530a by the DU of the parent node, e.g., IAB donor 510. The MT of IAB node 520b may operate as a scheduled node of parent node 520a. The DU may schedule the child IAB nodes 520b and UEs 530b of the IAB node 520a. As an IAB node may provide a connection to an IAB node that in turn provides a connection for another IAB node, the pattern of a parent IAB node comprising a DU that schedules a child IAB node/child UE may continue.

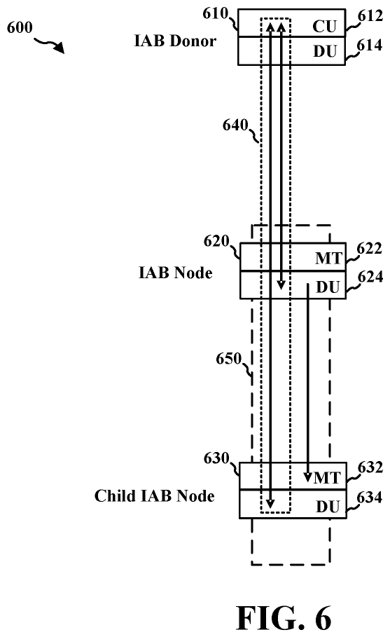

FIG. 6 illustrates examples of interaction 600 between an IAB donor 610, an IAB node 620, and a child IAB node 630 in accordance with various aspects of the present disclosure. The CU 612 of the IAB donor 610 may provide a centralized management of the resources available for communication of the IAB nodes. For example, the CU 612 of the IAB donor 610 may allocate the resources semi-statically. Additionally, or alternatively, the soft resources of a child node may be controlled in a distributed dynamic fashion by the parent of the child node (e.g., the DU 624 or 614 of the parent node). For example, the DU 624 of the IAB node 620 may allocate the soft resources of the child IAB node 630 through dynamic control signaling.

The MTs 622 and 632 may have resources that are downlink (DL) resources, uplink (UL) resources, or flexible (F) resources. In one example, the DUs 614, 624, and 634 may have hard DL resources, hard UL resources, and/or hard F resources. In another example, the DUs 614, 624, and 634 may have soft DL resources, soft UL resources, and/or soft flexible resources. In addition to hard or soft resources types, the DUs 614, 624, and 634 may have resources that are not available (NA) type resources.

The CU 612 of the IAB donor 610 may communicate with the DU 624 of the IAB node 620 and the DU 634 of the child IAB node 630 over an F1 interface 640. The F1 interface 640 may support exchanging information with or transferring encapsulated RRC messages to a child IAB node (e.g., the MT of a child of the receiving IAB node) (e.g., transferring an encapsulated RRC message for the child IAB node 630 to the DU 624 of the IAB node 620). In some aspects, the CU 612 may configure the resource pattern of the DU 624 of the IAB node 620 over the F1 interface 640.

The DU 624 of the IAB node 620 may communicate with the MT 632 of the child IAB node 630 over a Uu air interface 650. The Uu air interface 650 may support transferring RRC messages received from the CU 612 of the IAB donor 610 to the MT 632 of the child IAB node 630, and may support the DU 624 of the IAB node 620 dynamically scheduling the MT 632 of the child IAB node 630. In some aspects, the IAB node 620 may dynamically control the soft resources of the DU 634 of the child IAB node 630 over the Uu air interface 650.

In some scenarios, a CU (e.g., the CU 103, 612) may transmit to a DU one or more requests to perform one or more services, such as to serve a UE, to setup or modify a context for a UE, and/or to setup a data radio bearer (DRB) between the CU and a UE, etc. As the one or more requests may consume resources at the DU, the DU may respond by indicating to the CU whether the DU is able to perform the one or more requests. For example, if the DU has sufficient resources to perform the one or more requests, the DU may accept the one or more requests. The DU may reject the one or more requests, e.g., if the DU does not have sufficient resources to perform the one or more requests. In some examples, a DU accepting a request from a CU may be referred to as the DU “admitting” or by saying that the DU “admits” the request from the CU, and/or as the DU's “admission” to the CU's request, etc. As such, for purposes of the present disclosure, the term “admit(s)” and “admission(s)” may refer to a network entity (e.g., a DU, a CU) accepting or supporting service request(s) from another network entity. In addition, the process of a network entity determining or controlling whether to admit (e.g., accept) one or more requests from another network entity may be referred to as an “admission control.” In some examples, the admission may occur between a CU and a DU of a base station, which may be referred to as an intra-CU admission. In other examples, the admission may occur between a CU of a first base station and a CU of a second base station (e.g., between CUs of different base stations), which may be referred to as an inter-CU admission.

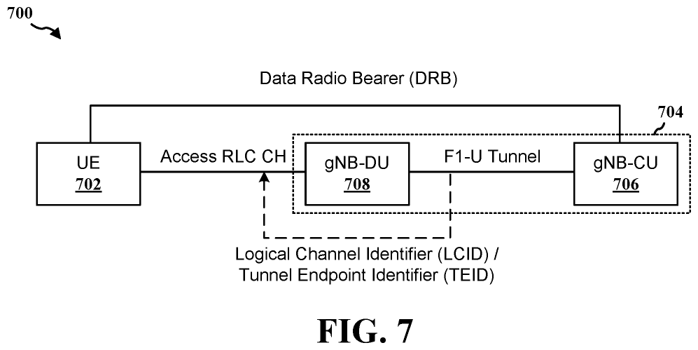

FIG. 7 is a diagram 700 illustrating an example of an intra-CU admission in accordance with various aspects of the present disclosure. A UE 702 may be connected to a base station 704, where the base station 704 may be split into a CU 706 and one or more DU 708, such as described in connection with FIGS. 1, 4, 5, and 6. In one example, the CU 706 may determine to establish a DRB between the CU 706 and the UE 702. In order to establish the connection to the UE 702 via the DU 708, the CU 706 may request the DU 708 to setup the DRB by providing a list of DRB(s) to be setup to the DU 708, which may also include quality of service (QoS) associated with each DRB (e.g., different DRBs may have different QoS and may consume different resources at the DU 708). For example, the QoS may include prioritization and/or scheduling for one or more UEs.

After the DU 708 receives the request to setup the DRB from the CU 706, the DU 708 may determine whether it has sufficient resources to perform the request. For example, if the DU 708 has sufficient resources to setup the DRB between the UE 702 and the CU 706, the DU 708 may admit the request. On the other hand, if the DU 708 does not have sufficient resource to perform the request, the DU 708 may reject the request. If DU 708 accepts the request, the DU 708 may establish an F1-U tunnel (e.g., an F1 interface between a CU and a DU) between the CU 706 and the DU 708 for the DRB to be setup (e.g., one F1-U tunnel may be associated with one DRB). Similarly, the DU 708 may also establish an access radio link control (RLC) channel (CH) (e.g., an air interface) between the UE 702 and the DU 708 for the DRB.

In one example, the DU 708 and/or the CU 706 may identify the traffic of a particular DRB based on a tunnel endpoint identifier (TEID) associated with the DRB. For example, when the CU 706 and the DU 708 set up an F1-U tunnel for a DRB, each of the CU 706 and the DU 708 may assign a TEID for the F1-U tunnel. When the CU 706 and the DU 708 exchange PDUs of a DRB on the F1-U tunnel, whether for DL transmission or UL transmission, the sender may include the TEID allocated by the receiver so that the receiver is able to identify the associated DRB.

Similarly, the UE 702 and the DU 708 may identify the traffic of a particular access RLC CH or respond to a particular access RLC CH over an air interface (e.g., for DL transmission and/or UL transmission) based on a logical channel identifier (LCID) in the packet(s) transmitted via the access RLC CH (e.g., each packet transmitted via the access RLC CH may be associated with an LCID). For example, when the DU 708 and the UE 702 setup up an access RLC CH, the access RLC CH may be identified by or associated with an LCID. When the DU 708 and the UE 702 are exchanging traffic (whether for DL or UL) on the access RLC CH, the traffic on the access RLC CH may carry the LCID. Thus, a receiver (e.g., the DU 708 or the UE 702) may read the LCID on the traffic and identify the associated DRB. For example, a first LCID may be associated with a first DRB, and a second LCID may be associated with a second DRB, etc. As such, if the UE 702 receives a traffic that includes a first LCID, the UE 702 may determine that the traffic is associated with the first DRB.

After an F-1 U tunnel is established between the CU 706 and the DU 708 and an access RLC CH is established between the UE 702 and the DU 708, the F-1 U tunnel and the access RLC CH may be bridged via the DU 708 to set up the corresponding DRB. For example, the bridging between the F1-U tunnel and the access RLC CH may occur at the DU 708 as the DU 7008 may be aware of the mapping between a DL TEID and an LCID in the DL and/or the mapping between an UL TEID and an LCID in the UL.

In other words, FIG. 7 illustrates an example of a CU providing a DU with a DRB to be setup list (similarly for backhaul (BH) RLC CHs), where the CU may include QoS information to be applied by the DU to the DRB or a QoS flow mapped to the DRB. Then, the DU may perform admission or rejection of the DRB based on the received QoS information. In some examples, for an inter-CU admission, a DU (e.g., the DU 708) may perform admission control and provide a new radio resource control (RRC) configuration as part of a handover (HO) request acknowledgement (ACK).

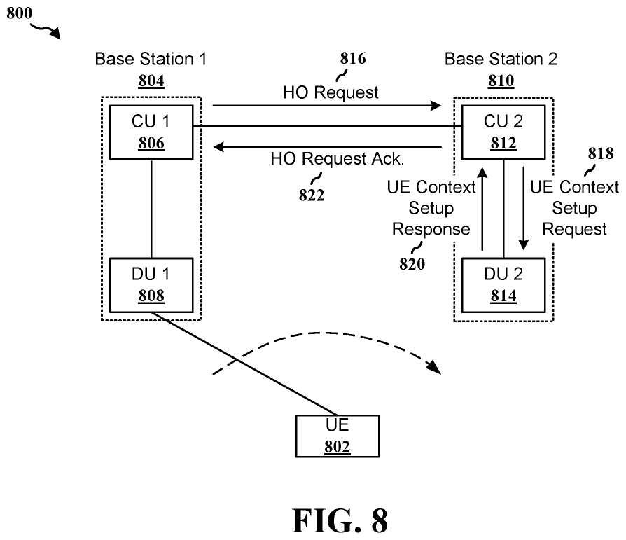

FIG. 8 is a diagram 800 illustrating an example of an inter-CU admission in accordance with various aspects of the present disclosure. A UE 802 may be connected to a first base station 804 that is split into a CU 806 and a DU 808, such as described in connection with FIGS. 1 and 4 to 7. In one example, as shown at 816, if the first base station 804 (or the CU 806 of the first base station 804) determines to handover (HO) the UE 802 to a second base station 810 that includes a CU 812 and a DU 814, the CU 806 of the first base station 804 may transmit a HO request to the CU 812 of the second base station 810.

At 818, the CU 812 of the second base station 810 may transmit a UE context setup request to the DU 814, where the UE context setup request may request the DU 814 to serve the UE 802 and/or services/resources specified for serving the UE 802.

At 820, the DU 814 may respond to the CU 812 whether the DU 814 is able to admit the UE context setup request (e.g., to serve the UE 802) in a UE context setup response message. For example, if the DU 814 has sufficient resources to serve the UE 802, the DU 814 may transmit an admission for the UE context setup request to the CU 812. On other hand, if the DU 814 does not have sufficient resources to serve the UE 802, the DU 814 may transmit a rejection for the UE context setup request to the CU 812.

At 822, based on whether the DU 814 of the second base station 810 is able to serve the UE 802, the CU 812 of the second base station 810 may transmit an acknowledgement (ACK)/admission message or a negative-acknowledgement (NACK)/rejection message to the CU 806 of the first base station 804 for the HO request from the first base station 804. For example, if the DU 814 has sufficient resources to serve the UE 802, the CU 812 of the second base station 810 may transmit an admission or an ACK message for the HO request to the CU 806 of the first base station 804. Then, the handover procedure may be completed when the connection between the UE 802 and the first base station 804 is switched to the second base station 810.

In some examples, a DU cell (e.g., the DU 708, 814) may be configured to operate under an energy saving mode in response to certain conditions and/or during certain times. For example, a DU cell may operate under an energy saving mode when there is a lower amount of traffic and/or during lower traffic times. For purposes of the present disclosure, the term “energy saving mode” may refer to a network entity (e.g., a DU) operating below a full capacity or processing capability, where the network entity may not be able to provide some of the services during the energy saving mode. For example, during an energy saving mode, a network entity may be configured to operate at a maximum of 50% of its full capacity or processing capability, and/or the network entity may be configured to provide limited services, etc.

In some scenarios, if a DU of a base station is in an energy saving mode and is providing limited services, capacity, and/or processing capability, the CU of the base station may not know which resources/services the DU currently supports or will admit. As such, the DU may be more likely to reject requests from the CU during an energy saving mode compared to the DU in a non-energy saving mode. For example, if a DU is configured to perform 20% of its services or resources during an energy saving mode and its corresponding CU is not aware of the services provided by the DU during the energy saving mode, the CU may transmit service requests to DU that are not supported by the DU during the energy saving mode, which may result in an increased number of service requests being rejected by the DU. The number of rejections may further increase in inter-CU admission scenarios as additional service requests may come from other base stations, such as described in connection with FIG. 8. The increased number of rejections may consume additional resources and power at a base station and/or between base stations, which may reduce the network performance and the latency of the communication.

Aspects presented herein may improve the performance and the latency of communication in a network by reducing or preventing a network entity (e.g., a CU) from requesting one or more services that are not supported by another network entity (e.g., a DU), such that the number of rejections for service requests between network entities may be reduced to improve network resource utilizations. For example, aspects presented herein may enable a first network entity (e.g., a DU) to proactively indicate, to a second network entity (e.g., a CU), the general type of request(s) the first network entity is capable of or willing to admit, which may be based on the first network entity's energy saving mode. In response, the second network entity may take the general type of request(s) that the first network entity currently supports or will admit into account when the second network entity is transmitting service request(s) to the first network entity. In some examples, the general type of request(s) the first network entity supports or will to admit may include the type of device(s) (e.g., UE, IAB-node, repeaters, etc.), device/child capability, traffic type (e.g., GBR, non-GBR), and/or traffic QoS, etc.

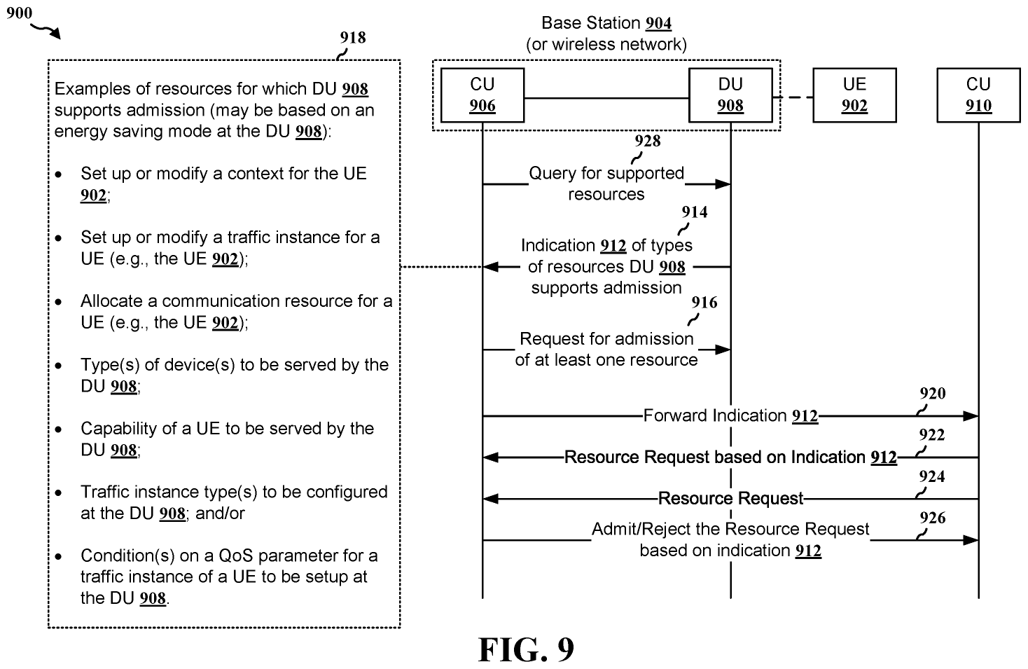

FIG. 9 is a communication flow 900 illustrating an example of a DU indicating to a CU type(s) of resource(s) for which the DU supports admission in accordance with various aspects of the present disclosure. The numberings associated with the communication flow 900 do not specify a particular temporal order and are merely used as references for the communication flow 900. In one example, a base station 904 (or a wireless network) may include at least a CU 906 and a DU 908, and the DU 908 may or may not be connected to a UE 902, such as described in connection with FIGS. 1 and 4 to 8.

At 914, the DU 908 may transmit an indication 912 that indicates one or more types of resources (may also be referred to as “services”) for which the DU 908 may support admission (e.g., may be able to accept). In one example, the indication 912 may be associated with an energy saving mode of the DU 908 or associated with an operation below a full capacity of the DU 908. In other words, the DU 908 may transmit the indication 912 to the CU 906 or other network entities based on an energy saving schedule/mode of the DU, a DU cell, and/or a DU resource, etc. For example, a DU may service multiple cells via different transmission and reception points (TRPs) of the DU, where different cells may use different physical resources (e.g., served by different TRPs). Thus, the indication 912 may be associated with the DU 908 as a whole, associated with a cell of the DU 908, and/or associated with a resource of the DU 908, etc.

At 916, in response to the indication 912, the CU 906 may transmit, to the DU 908, a request for admission of at least one resource based at least in part on the one or more types of resources indicated by the DU 908. For example, if the indication 912 indicates that the DU 908 is currently capable of admitting (e.g., supporting) resource A, resource B, and resource C, the CU 906 may request the DU 908 to perform one or more of the resource A, the resource B, and/or the resource C based at least in part on the indication 912. However, the CU 906 may refrain from requesting, e.g., skip transmitting a request to, the DU 908 from admitting/performing resources that are not supported by the DU 908 (e.g., resources not indicated by the indication 912), such as resource D, resource E, etc. As such, by informing the CU 906 of a list of resources (e.g., services) supported by the DU 908, such as a list of resources supported by the DU 908 during an energy saving mode of the DU 908, the CU 906 may avoid transmitting resource request(s) to the DU 908 that are not supported by the DU 908, thereby reducing the number of rejection(s) from the DU 908.

As shown at 918, in one aspect, the indication 912 for one or more types of resources for which the DU 908 supports admission may include setting up or modifying a context for a UE (e.g., the UE 902) at the DU 908. For example, if the DU 908 is connected to the UE 902, the CU 906 may request the DU 908 to setup or modify a context for the UE 902, such as by transmitting a UE context setup/modify request to the DU 908 as described in connection with FIG. 8. Thus, if the DU 908 supports or has resources for setting up or modifying a context for the UE 902 (e.g., currently or during an energy saving mode), the DU 908 may include such service/resource in the indication 912 at 914. Then, based at least in part on the indication 912, the CU 906 may be able to transmit a request to setup or modify a context for the UE 902 to the DU 908 at 916. However, if the indication 912 does not include the resource for setting up or modifying a context for a UE, then the CU 906 may be refrained from requesting such service/resource from the DU 908 at 916. In some examples, the UE context setup/modify request may include multiple information elements (IEs), such as DRBs to be setup list. In response, the DU 908 may admit the IEs supports by the DU 908 and reject IEs not supported by the DU 908.

In another aspect, the indication 912 for one or more types of resources for which the DU 908 supports admission may include setting up or modifying a traffic instance for a UE (e.g., the UE 902) at the DU 908. For example, if the DU 908 is connected to the UE 902, the CU 906 may request the DU 908 to setup or modify a traffic instance for the UE 902, where the traffic instance may be a DRB (e.g., a DRB between the CU 906 and the UE 902), an F1-U tunnel (e.g., between the DU 908 and the CU 906), a QoS flow (e.g., a QoS flow that is mapped or associated with a DRB), and/or a backhaul (BH) RLC CH (e.g., for an IAB network), etc. Thus, if the DU 908 supports or has resources for setting up or modifying a traffic instance for the UE 902 (e.g., currently or based on an mode such as during an energy saving mode), the DU 908 may include such service/resource in the indication 912 at 914. Then, based at least in part on the indication 912, the CU 906 may be able to transmit a request to setup or modify a traffic instance for the UE 902 to the DU 908 at 916. However, if the indication 912 does not include the resource for setting up or modifying a traffic instance for a UE, then the CU 906 may be refrained from requesting such service/resource from the DU 908 at 916.

In another aspect, the indication 912 for one or more types of resources for which the DU 908 supports admission may include allocating a communication resource for serving a UE (e.g., the UE 902). For example, if the DU 908 is connected to the UE 902 or if the CU 906 is requesting the DU 908 to serve another UE, the CU 906 may request the DU 908 to allocate a communication resource for the UE 902 or another UE. In one example, the communication resource may be a time resource, a frequency resource, a spatial resource, or a combination thereof. In another example, the communication resource may be adding additional cell(s), such as addition of a second cell (SCell), to increase the bandwidth or the throughput for a UE. Thus, if the DU 908 supports or has resources for allocating communication resource(s) for one or more UEs (e.g., currently or during an energy saving mode), the DU 908 may include such service/resource in the indication 912 at 914. Then, based at least in part on the indication 912, the CU 906 may be able to transmit a request to allocate communication resource(s) for one or more UEs to the DU 908 at 916. However, if the indication 912 does not include the resource for allocating communication resource(s) for one or more UEs, then the CU 906 may be refrained from requesting such service/resource from the DU 908 at 916.

In another aspect, the indication 912 for one or more types of resources for which the DU 908 supports admission may include at least one type of device (or a type of child/children) that may be served by the DU 908. For example, at 914, the DU 908 may indicate to the CU 906 that it is capable of serving a UE, an IAB node, a repeater, or a combination of (e.g., currently or based on a mode such as during an energy saving mode). A repeater may be an electronic device that takes a wireless signal and amplifies it across a local area. Then, based at least in part on the indication 912, at 916, the CU 906 may request the DU 908 to serve at least one type of device for which the DU 908 is capable of serving. However, the CU 906 may refrain from requesting, e.g., skip transmitting a request to, the DU 908 to serve type(s) of device(s) for which the DU 908 does not indicate it is capable of serving.

In another aspect, the indication 912 for one or more types of resources for which the DU 908 supports admission may be associated with at least one capability of a UE to be served by the DU 908. In one example, the capability of a UE may include a beam correspondence associated with beam sweeping (e.g., for uplink). For example, when a UE is connecting to a DU, the UE may determine at least one reception beam for receiving traffics from the DU and at least one transmission beam for transmitting traffics to the DU based on beam sweeping. Similarly, the DU may also determine at least one reception beam for receiving traffics from the UE and at least one transmission beam for transmitting traffics to the UE based on beam sweeping. However, in some scenarios, a UE may have the capability to determine a beam (e.g., a best beam) for transmitting and/or receiving the traffics from a DU, and the UE may indicate such beam to the DU. Based on the beam indication, the DU may determine which transmission beam(s) and/or reception beam(s) may be used for communicating with the UE without performing beam sweeping, which may reduce power consumption at the DU. As such, under certain conditions, such as when a DU is under an energy saving mode, the DU may determine to serve UEs that are capable of providing beam correspondence, and may determine not to serve UEs without such capability.

In another example, the capability of a UE may include a processing time associated with a UE receiving a physical downlink shared channel (PDSCH) and sending a corresponding hybrid automatic repeat request (HARQ) feedback. For example, when a UE receives a packet from a DU (e.g., via a PDSCH), the UE may report to the DU whether it successfully/correctly receives the packet by sending an acknowledgement (ACK) or a negative-acknowledgement (NACK) to the DU, such that the DU may determine whether to retransmit the packet. As UEs with different capabilities or processing abilities may specify different processing times between receiving the PDSCH and transmitting a corresponding HARQ feedback, different processing times may result in different power consumptions at the DU. For example, if it takes a longer time for a UE to process a PDSCH and to transmit a corresponding HARQ feedback, the DU may be specified to take a longer time to monitor for the corresponding HARQ feedback from the UE, which may increase power consumption at the DU. On the other hand, if the time for a UE to process a PDSCH and to transmit a corresponding HARQ feedback is relatively short, the DU may spend less time monitoring for the corresponding HARQ feedback from the UE, which may reduce the power consumption at the DU. Thus, under certain conditions, such as when a DU is under an energy saving mode, the DU may determine to serve UEs with a processing time that is below a processing time threshold, and may determine not to serve UEs with a processing time that is above the processing time threshold.

In another example, the capability of a UE may include whether the UE is capable of providing cross link interference (CLI) measurement and reporting, and/or whether the UE supports full-duplex transmission (e.g., simultaneous data transmission and receptions over one channel), such that a DU may serve the UE in a more efficient manner. For example, if a UE supports full-duplex transmission, it may take a shorter time for a DU to communicate with the UE as the UE is capable of transmitting and receiving data simultaneously. Thus, under certain conditions, such as when a DU is under an energy saving mode, the DU may determine to serve UEs that support full-duplex transmission, and may determine not to serve UEs that do not support full-duplex transmission.

As such, at 914, the DU 908 may indicate to the CU 906 at least one capability of a UE to be served by the DU 908. Then, based at least in part on the indication 912, at 916, the CU 906 may request the DU 908 to serve UE(s) with the at least one capability. However, the CU 906 may refrain from requesting, e.g., skip transmitting a request to, the DU 908 to serve UE(s) that do not include the at least one capability.

In another aspect, the indication 912 for one or more types of resources for which the DU 908 supports admission may include a traffic instance type to be configured at the DU 908. For example, at 914, the DU 908 may indicate to the CU 906 that it is capable of providing/admitting a non-guaranteed bit rate (GBR) traffic (e.g., for a radio bearer), a GRB traffic, a delay-critical GBR traffic, a time sensitive communication (TSC) traffic, or a combination thereof, etc. Then, based at least in part on the indication 912, at 916, the CU 906 may request the DU 908 to configure one or more traffic instance types supported by the DU 908 for a UE (e.g., the UE 902). However, the CU 906 may refrain from requesting the DU 908 to configure a traffic instance type that is not supported by the DU 908.

In another aspect, the indication 912 for one or more types of resources for which the DU 908 supports admission may be associated with a condition on a QoS parameter for a traffic instance of a UE to be setup at the DU 908. In one example, the condition on a QoS parameter for a traffic instance of a UE may be a guaranteed flow bit rate below a bit rate threshold, and/or a packet delay budget above a delay budget threshold, etc. For example, when a DU is operating under an energy saving mode, the DU may support a guaranteed flow bit rate (e.g., a transmission bandwidth) that is below a bit rate threshold to conserve resources and the power at the DU (e.g., higher guaranteed flow bit rate may increase resources consumed at the DU). Thus, at 914, the DU 908 may indicate to the CU 906 a condition on a QoS parameter for a traffic instance of a UE that may be setup at the DU 908 in the indication 912. Then, based at least in part on the indication 912, at 916, the CU 906 may request the DU 908 to setup a traffic instance for a UE that satisfies the condition indicated by the DU 908. However, the CU 906 may refrain from requesting the DU 908 to setup a traffic instance for a UE that does not satisfy the condition indicated by the DU 908.

In some examples, the indication 912 may be associated with a UE (e.g., the indication 912 is UE-associated), such as associated with the UE 902. For example, the indication 912 may indicate whether the DU 908 is admitting request to setup or modify a context or traffic instance for the UE 902. In other examples, the indication 912 may not be associated with a UE (e.g., the indication 912 is non-UE-associated), where the indication 912 may indicate one or more general resource/service types that are supported by the DU 908, which may be applicable to multiple UEs (e.g., not applying to a particular UE). For example, the indication 912 may indicate type(s) of device(s) and/or traffic(s) admitted by the DU 908 that are not specific to a particular UE.

In another aspect of the present disclosure, as shown at 920, the CU 906 may forward the indication 912 to another CU, such as a CU 906 of another base station. Then, at 922, in response to the received indication 912, the CU 906 may transmit a resource request to the CU 906 based on the indication 912 to minimize or avoid rejections between CUs from different base stations (e.g., for inter-CU admission scenarios). For example, referring back to FIG. 8, the DU 814 of the second base station 810 may transmit an indication (e.g., the indication 912) to the CU 812 indicating resource(s) for which the DU 814 is willing to admit, such as whether it is willing to setup a traffic for a UE (e.g., for a HO request) and/or adding a second node (SN) for a UE, etc., and the CU 812 may forward the indication to the CU 806 of the first base station 804. Then, based at least in part on the received indication, the CU 806 may transmit a resource request to the CU 812 requesting resource(s)/service(s) supported by the DU 814, and the CU 806 may refrain from requesting, e.g., skip transmitting a request to, the CU 812 for resources/services that are not supported by the DU 814 to minimize or avoid the number of serve requests being rejected. As such, the indication may include DU 814's capability/willingness to admit HO request and/or SN addition request.

In another aspect of the present disclosure, as shown at 924, the CU 906 may receive a resource request from another CU, such the CU 906 of another base station. As the CU 906 may be aware of types of resources/services for which the DU 908 supports admission based on the indication 912, the CU 906 may admit or reject the resource request from another CU based at least in part on the indication 912. This may further reduce the number of resource requests from the CU 906 to the DU 908, such as during inter-CU admission scenarios described in connection with FIG. 8.

In another aspect of the present disclosure, as shown at 928, in some scenarios, the CU 906 may transmit, to the DU 908, a query for a list of resources in which the DU is capable of admitting. Then, at 914, in response to the query, the DU 908 may transmit the indication 912 that indicates one or more types of resources for which the DU 908 supports admission. In other words, the DU 908 may be configured to transmit the indication 912 based on the CU 906's request.

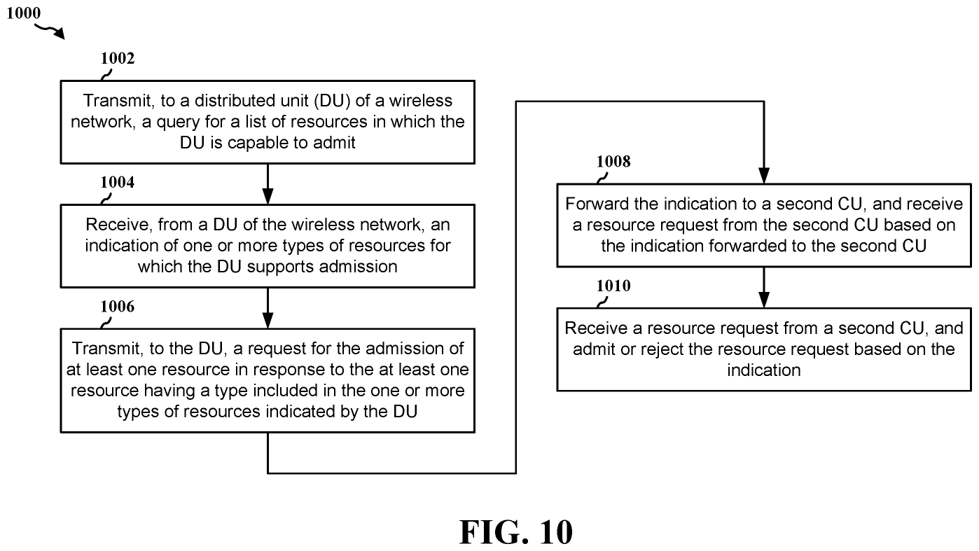

FIG. 10 is a flowchart 1000 of a method of wireless communication. The method may be performed by a CU of a wireless network/base station or a component of a CU (e.g., the CU 103, 612, 706, 806, 812, 906; the apparatus 1202; a processing system, which may include the memory 376 and which may be the entire base station 310 or a component of the base station 310, such as the TX processor 316 the RX processor 370, and/or the controller/processor 375). The method may enable the CU to receive type(s) of request(s) a DU is capable of admitting, such that the CU may transmit request(s) to the DU based on the type(s) of request(s) supported by the DU to improve network resource utilization.

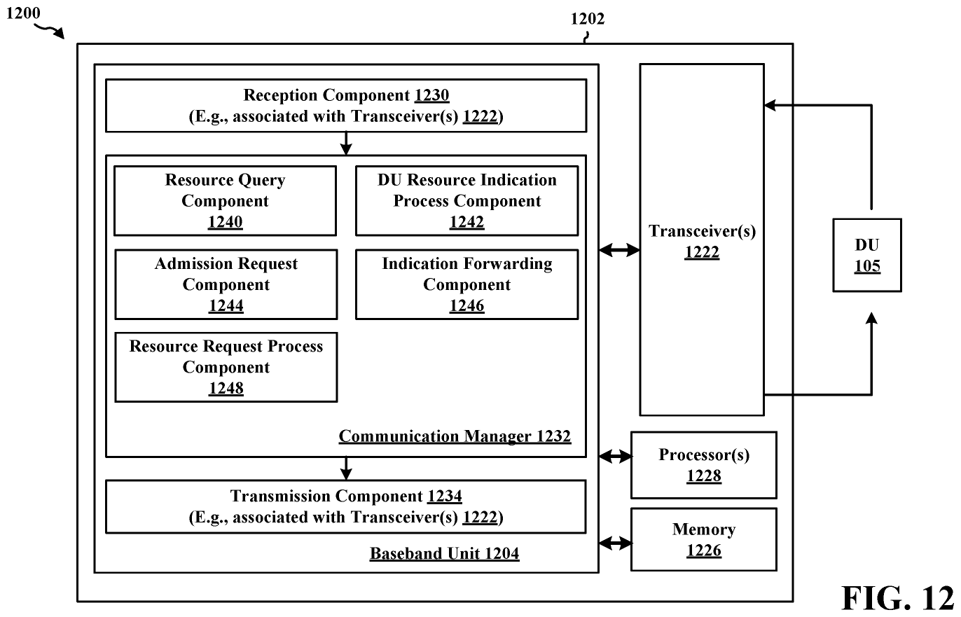

At 1004, the CU may receive, from a DU of the wireless network, an indication of one or more types of resources for which the DU supports admission, such as described in connection with FIG. 9. For example, at 914, the CU 906 may receive, from the DU 908, an indication 912 of one or more types of resources for which the DU 908 supports admission. The reception of the indication may be performed by, e.g., the DU resource indication process component 1242 and/or the reception component 1230 of the apparatus 1202 in FIG. 12.

In one example, at 1002, the CU may transmit, to the DU, a query for a list of resources in which the DU is capable to admit, and the CU may receive, from the DU, the indication based on the query, such as described in connection with FIG. 9. For example, at 928, the CU 906 may transmit, to the DU 908, a query for a list of resources in which the DU 908 is capable to admit, and at 914, the CU 906 may receive the indication 912 from the DU 908 based on the query. The transmission of the query may be performed by, e.g., the resource query component 1240 and/or the transmission component 1234 of the apparatus 1202 in FIG. 12.

At 1006, the CU may transmit, to the DU, a request for the admission of at least one resource in response to the at least one resource having a type included in the one or more types of resources indicated by the DU, such as described in connection with FIG. 9. For example, at 916, the CU 906 may transmit, to the DU 908, a request for the admission of at least one resource in response to the at least one resource having a type included in the one or more types of resources indicated by the DU 908. The transmission of the request for the admission may be performed by, e.g., the admission request component 1244 and/or the transmission component 1234 of the apparatus 1202 in FIG. 12.

In one example, the indication may be associated with a particular mode of the DU, such as an energy saving mode of the DU or operation below a full capacity of the DU.

In another example, the request for the admission of the at least one resource may request the DU to set up or modify a context for a UE.

In another example, the request for the admission of the at least one resource may request the DU to set up or modify a traffic instance for a UE. In such an example, the traffic instance may include at least one of: a DRB, an F1-U tunnel, a QoS flow, or a BH RLC CH.

In another example, the request for the admission of the at least one resource may request the DU to allocate a communication resource for a UE. In such an example, the communication resource may include at least one of: a time resource, a frequency resource, or a spatial resource.

In another example, the one or more types of resources for which the DU supports the admission may include a type of device to be served by the DU. In such an example, the type of device may include at least one of: a UE, an IAB node, or a repeater that is served by the DU.

In another example, the one or more types of resources for which the DU supports the admission may be associated with at least one capability of a UE to be served by the DU. In such an example, the at least one capability of the UE may include at least one of: a beam correspondence associated with beam sweeping, a processing time associated with receiving a PDSCH and sending a corresponding HARQ feedback, a support of CLI measurement and reporting, or a full or half duplex capability.

In another example, the one or more types of resources for which the DU supports the admission may include a traffic instance type to be configured at the DU. In such an example, the traffic type may include at least one of: a non-GBR traffic, a GBR traffic, a delay-critical GBR traffic, or a TSC traffic.

In another example, the one or more types of resources for which the DU supports the admission may be associated with a condition on a QoS parameter for a traffic instance of a UE to be setup at the DU. In such an example, the condition may include at least one of: a guaranteed flow bit rate below a bit rate threshold, or a packet delay budget above a delay budget threshold.

In another example, the indication may be associated with a UE. In another example, the indication may be applicable to multiple UEs.

At 1008, the CU may forward the indication to a second CU, and the CU may receive a resource request from the second CU based on the indication forwarded to the second CU, such as described in connection with FIG. 9. For example, at 920, the CU 906 may forward the indication 912 to the CU 910, and at 922, the CU 906 may receive a resource request from the CU 910 based on the indication 912 forwarded to the CU 910. The forwarding of the indication and the reception of the resource request may be performed by, e.g., the indication forwarding component 1246, the transmission component 1234, and/or the reception component 1230 of the apparatus 1202 in FIG. 12. In one example, the resource request may include at least one of: a handover request, or a secondary node addition request.

At 1010, the CU may receive a resource request from a second CU, and the CU may admit or reject the resource request based on the indication, such as described in connection with FIG. 9. For example, at 924, the CU 906 may receive a resource request from the CU 910, and at 926, the CU 906 may admit or reject the resource request based on the indication 912. The reception of the resource request and admission/rejection of the resource request may be performed by, e.g., the resource request process component 1248, the transmission component 1234, and/or the reception component 1230 of the apparatus 1202 in FIG. 12.

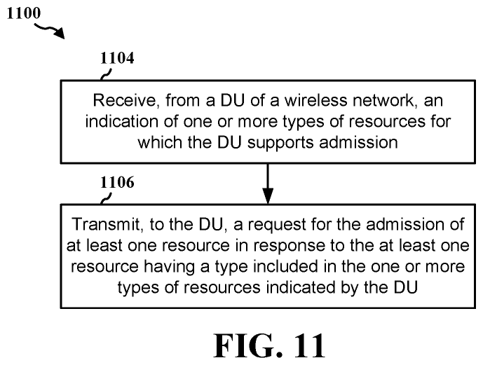

FIG. 11 is a flowchart 1100 of a method of wireless communication. The method may be performed by a CU of a wireless network/base station or a component of a CU (e.g., the CU 103, 612, 706, 806, 812, 906; the apparatus 1202; a processing system, which may include the memory 376 and which may be the entire base station 310 or a component of the base station 310, such as the TX processor 316 the RX processor 370, and/or the controller/processor 375). The method may enable the CU to receive type(s) of request(s) a DU is capable of admitting, such that the CU may transmit request(s) to the DU based on the type(s) of request(s) supported by the DU to improve network resource utilization.

At 1104, the CU may receive, from a DU of the wireless network, an indication of one or more types of resources for which the DU supports admission, such as described in connection with FIG. 9. For example, at 914, the CU 906 may receive, from the DU 908, an indication 912 of one or more types of resources for which the DU 908 supports admission. The reception of the indication may be performed by, e.g., the DU resource indication process component 1242 and/or the reception component 1230 of the apparatus 1202 in FIG. 12.

In one example, the CU may transmit, to the DU, a query for a list of resources in which the DU is capable to admit, and the CU may receive, from the DU, the indication based on the query, such as described in connection with FIG. 9. For example, at 928, the CU 906 may transmit, to the DU 908, a query for a list of resources in which the DU 908 is capable to admit, and at 914, the CU 906 may receive the indication 912 from the DU 908 based on the query. The transmission of the query may be performed by, e.g., the resource query component 1240 and/or the transmission component 1234 of the apparatus 1202 in FIG. 12.

At 1106, the CU may transmit, to the DU, a request for the admission of at least one resource in response to the at least one resource having a type included in the one or more types of resources indicated by the DU, such as described in connection with FIG. 9. For example, at 916, the CU 906 may transmit, to the DU 908, a request for the admission of at least one resource in response to the at least one resource having a type included in the one or more types of resources indicated by the DU 908. The transmission of the request for the admission may be performed by, e.g., the admission request component 1244 and/or the transmission component 1234 of the apparatus 1202 in FIG. 12.

In one example, the indication may be associated with an energy saving mode of the DU or operation below a full capacity of the DU.

In another example, the request for the admission of the at least one resource may request the DU to set up or modify a context for a UE.

In another example, the request for the admission of the at least one resource may request the DU to set up or modify a traffic instance for a UE. In such an example, the traffic instance may include at least one of: a DRB, an F1-U tunnel, a QoS flow, or a BH RLC CH.

In another example, the request for the admission of the at least one resource may request the DU to allocate a communication resource for a UE. In such an example, the communication resource may include at least one of: a time resource, a frequency resource, or a spatial resource.

In another example, the one or more types of resources for which the DU supports the admission may include a type of device to be served by the DU. In such an example, the type of device may include at least one of: a UE, an IAB node, or a repeater that is served by the DU.

In another example, the one or more types of resources for which the DU supports the admission may be associated with at least one capability of a UE to be served by the DU. In such an example, the at least one capability of the UE may include at least one of: a beam correspondence associated with beam sweeping, a processing time associated with receiving a PDSCH and sending a corresponding HARQ feedback, a support of CLI measurement and reporting, or a full or half duplex capability.

In another example, the one or more types of resources for which the DU supports the admission may include a traffic instance type to be configured at the DU. In such an example, the traffic type may include at least one of: a non-GRB traffic, a GRB traffic, a delay-critical GBR traffic, or a TSC traffic.

In another example, the one or more types of resources for which the DU supports the admission may be associated with a condition on a QoS parameter for a traffic instance of a UE to be setup at the DU. In such an example, the condition may include at least one of: a guaranteed flow bit rate below a bit rate threshold, or a packet delay budget above a delay budget threshold.

In another example, the indication may be associated with a UE. In another example, the indication may be applicable to multiple UEs.

In another example, the CU may forward the indication to a second CU, and the CU may receive a resource request from the second CU based on the indication forwarded to the second CU, such as described in connection with FIG. 9. For example, at 920, the CU 906 may forward the indication 912 to the CU 910, and at 922, the CU 906 may receive a resource request from the CU 910 based on the indication 912 forwarded to the CU 910. The forwarding of the indication and the reception of the resource request may be performed by, e.g., the indication forwarding component 1246, the transmission component 1234, and/or the reception component 1230 of the apparatus 1202 in FIG. 12. In one example, the resource request may include at least one of: a handover request, or a secondary node addition request.

In another example, the CU may receive a resource request from a second CU, and the CU may admit or reject the resource request based on the indication, such as described in connection with FIG. 9. For example, at 924, the CU 906 may receive a resource request from the CU 910, and at 926, the CU 906 may admit or reject the resource request based on the indication 912. The reception of the resource request and admission/rejection of the resource request may be performed by, e.g., the resource request process component 1248, the transmission component 1234, and/or the reception component 1230 of the apparatus 1202 in FIG. 12.

FIG. 12 is a diagram 1200 illustrating an example of a hardware implementation for an apparatus 1202. The apparatus 1202 may be a CU of a wireless network/base station, a component of a CU, or may implement CU functionality. In some aspects, the apparatus 1202 may include a baseband unit 1204. The baseband unit 1204 may communicate through at least one transceiver 1222 (e.g., one or more RF transceivers and/or antennas) with a DU (e.g., the DU 105). The at least one transceiver 1222 may be associated with or include a reception component 1230 and/or a transmission component 1234. The baseband unit 1204 may include a computer-readable medium/memory (e.g., a memory 1226). The baseband unit 1204 and/or the at least one processor 1228 may be responsible for general processing, including the execution of software stored on the computer-readable medium/memory. The software, when executed by the baseband unit 1204 and/or the at least one processor 1228, causes the baseband unit 1204 and/or the at least one processor 1228 to perform the various functions described supra. The computer-readable medium/memory may also be used for storing data that is manipulated by the baseband unit 1204 when executing software. The baseband unit 1204 further includes the reception component 1230, a communication manager 1232, and the transmission component 1234. The reception component 1230 and the transmission component 1234 may, in a non-limiting example, include at least one transceiver and/or at least one antenna subsystem. The communication manager 1232 includes the one or more illustrated components. The components within the communication manager 1232 may be stored in the computer-readable medium/memory and/or configured as hardware within the baseband unit 1204. The baseband unit 1204 may be a component of the CU and may include the memory 376 and/or at least one of the TX processor 316, the RX processor 370, and the controller/processor 375.

The communication manager 1232 includes a resource query component 1240 that transmits, to the DU, a query for a list of resources in which the DU is capable to admit, e.g., as described in connection with 1002 of FIG. 10. The communication manager 1232 further includes a DU resource indication process component 1242 that receives, from a DU of the wireless network, an indication of one or more types of resources for which the DU supports admission, e.g., as described in connection with 1004 of FIGS. 10 and/or 1104 of FIG. 11. The communication manager 1232 further includes an admission request component 1244 that transmits, to the DU, a request for the admission of at least one resource in response to the at least one resource having a type included in the one or more types of resources indicated by the DU, e.g., as described in connection with 1006 of FIGS. 10 and/or 1106 of FIG. 11. The communication manager 1232 further includes an indication forwarding component 1246 that forwards the indication to a second CU, and receives a resource request from the second CU based on the indication forwarded to the second CU, e.g., as described in connection with 1008 of FIG. 10. The communication manager 1232 further includes a resource request process component 1248 that receives a resource request from a second CU, and admits or rejects the resource request based on the indication, e.g., as described in connection with 1010 of FIG. 10.

The apparatus may include additional components that perform each of the blocks of the algorithm in the flowcharts of FIGS. 10 and 11. As such, each block in the flowcharts of FIGS. 10 and 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1202 may include a variety of components configured for various functions. In one configuration, the apparatus 1202, and in particular the baseband unit 1204, includes means for transmitting, to the DU, a query for a list of resources in which the DU is capable to admit (e.g., the resource query component 1240, the transmission component 1234, and/or the reception component 1230). The apparatus 1202 includes means for receiving, from a DU of the wireless network, an indication of one or more types of resources for which the DU supports admission (e.g., the DU resource indication process component 1242 and/or the reception component 1230). The apparatus 1202 includes means for transmitting, to the DU, a request for the admission of at least one resource in response to the at least one resource having a type included in the one or more types of resources indicated by the DU (e.g., the admission request component 1244 and/or the transmission component 1234). The apparatus 1202 includes means for forwarding the indication to a second CU and means for receiving a resource request from the second CU based on the indication forwarded to the second CU (e.g., indication forwarding component 1246, the transmission component 1234, and/or the reception component 1230). The apparatus 1202 includes means for receiving a resource request from a second CU and means for admitting or rejecting the resource request based on the indication (e.g., the resource request process component 1248, the transmission component 1234, and/or the reception component 1230).

The means may be one or more of the components of the apparatus 1202 configured to perform the functions recited by the means. As described supra, the apparatus 1202 may include the TX Processor 316, the RX Processor 370, and the controller/processor 375. As such, in one configuration, the means may be the TX Processor 316, the RX Processor 370, and the controller/processor 375 configured to perform the functions recited by the means.

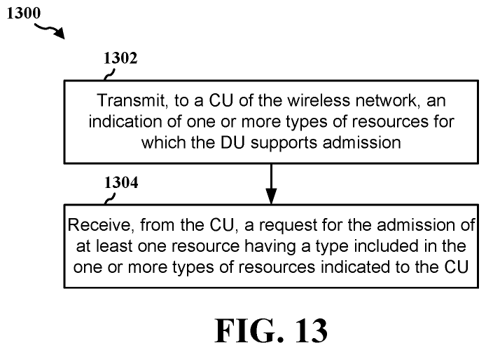

FIG. 13 is a flowchart 1300 of a method of wireless communication. The method may be performed by a DU of a wireless network/base station or a component of a DU (e.g., the DU 105, 614, 708, 808, 814, 908; the apparatus 1402; a processing system, which may include the memory 376 and which may be the entire base station 310 or a component of the base station 310, such as the TX processor 316 the RX processor 370, and/or the controller/processor 375). The method may enable the DU to provide type(s) of request(s) the DU is capable of admitting to a CU, such that the CU may transmit request(s) to the DU based on the type(s) of request(s) supported by the DU to improve network resource utilization.

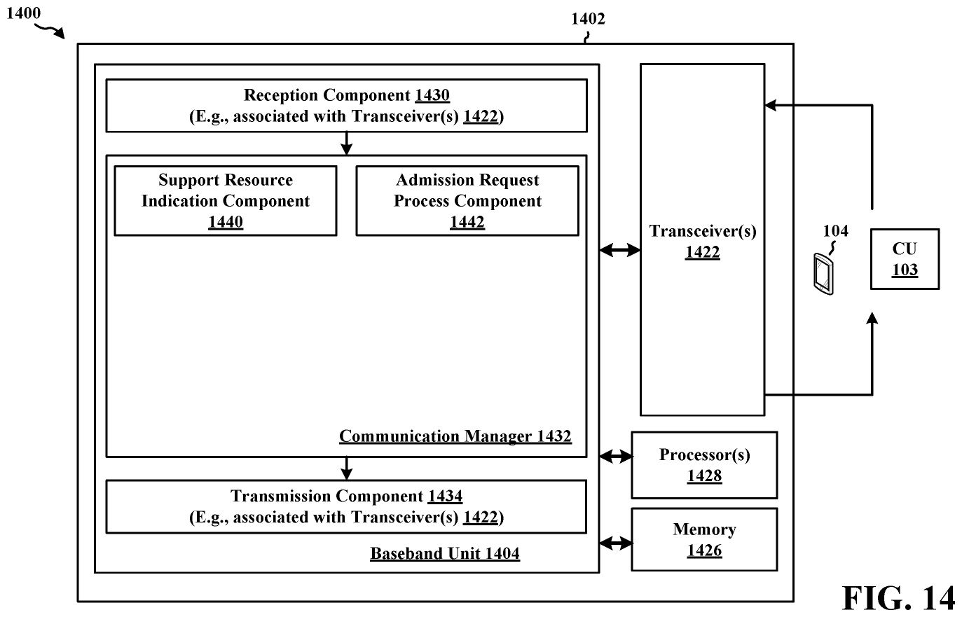

At 1302, the DU may transmit, to a CU of the wireless network, an indication of one or more types of resources for which the DU supports admission, such as described in connection with FIG. 9. For example, at 914, the DU 908 transmit, to the CU 906, an indication 912 of one or more types of resources for which the DU 908 supports admission. The transmission of the indication may be performed by, e.g., the support resource indication component 1440 and/or the transmission component 1434 of the apparatus 1402 in FIG. 14.

At 1304, the DU may receive, from the CU, a request for the admission of at least one resource having a type included in the one or more types of resources indicated to the CU, such as described in connection with FIG. 9. For example, at 916, the DU 908 may receive, from the CU 906, a request for the admission of at least one resource having a type included in the one or more types of resources indicated to the CU 906. The reception of the request may be performed by, e.g., the admission request process component 1442 and/or the reception component 1430 of the apparatus 1402 in FIG. 14.

In one example, the DU may operate in an energy saving mode or below a full capacity and transmit the indication based on operation in the energy saving mode or below the full capacity.

In another example, the request for the admission of the at least one resource may request the DU to set up or modify a context for a UE.

In another example, the request for the admission of the at least one resource may request the DU to set up or modify a traffic instance for a UE. In such an example, the traffic instance may include at least one of: a DRB, an F1-U tunnel, a QoS flow, or a BH RLC CH.

In another example, the request for the admission of the at least one resource may request the DU to allocate a communication resource for a UE. In such an example, the communication resource may include at least one of: a time resource, a frequency resource, or a spatial resource.

In another example, the one or more types of resources for which the DU supports the admission may include a type of device to be served by the DU. In such an example, the type of device may include at least one of: a UE, an IAB node, or a repeater that is served by the DU.

In another example, the one or more types of resources for which the DU supports the admission may be associated with at least one capability of a UE to be served by the DU. In such an example, the at least one capability of the UE may include at least one of: a beam correspondence associated with beam sweeping, a processing time associated with receiving a PDSCH and sending a corresponding HARQ feedback, a support of CLI measurement and reporting, or a full or half duplex capability.

In another example, the one or more types of resources for which the DU supports the admission may include a traffic instance type to be configured at the DU. In such an example, the traffic type may include at least one of: a non-GRB traffic, a GRB traffic, a delay-critical GBR traffic, or a TSC traffic.

In another example, the one or more types of resources for which the DU supports the admission may be associated with a condition on a QoS parameter for a traffic instance of a UE to be setup at the DU. In such an example, the condition may include at least one of: a guaranteed flow bit rate below a bit rate threshold, or a packet delay budget above a delay budget threshold.

In another example, the indication may be associated with a UE. In another example, the indication may be applicable to multiple UEs.

In another example, the DU may receive, from the CU, a query for a list of resources in which the DU is capable to admit, and the DU may transmit, to the CU, the indication based on the query.

FIG. 14 is a diagram 1400 illustrating an example of a hardware implementation for an apparatus 1402. The apparatus 1402 may be a DU of a wireless network/base station, a component of a DU, or may implement DU functionality. In some aspects, the apparatus 1402 may include a baseband unit 1404. The baseband unit 1404 may communicate through at least one transceiver 1422 (e.g., one or more RF transceivers and/or antennas) with the UE 104 or with the CU 103. The at least one transceiver 1422 may be associated with or include a reception component 1430 and/or a transmission component 1434. The baseband unit 1404 may include a computer-readable medium/memory (e.g., a memory 1426). The baseband unit 1404 and/or the at least one processor 1428 may be responsible for general processing, including the execution of software stored on the computer-readable medium/memory. The software, when executed by the baseband unit 1404 and/or the at least one processor 1428, causes the baseband unit 1404 and/or the at least one processor 1428 to perform the various functions described supra. The computer-readable medium/memory may also be used for storing data that is manipulated by the baseband unit 1404 when executing software. The baseband unit 1404 further includes the reception component 1430, a communication manager 1432, and the transmission component 1434. The reception component 1430 and the transmission component 1434 may, in a non-limiting example, include at least one transceiver and/or at least one antenna subsystem. The communication manager 1432 includes the one or more illustrated components. The components within the communication manager 1432 may be stored in the computer-readable medium/memory and/or configured as hardware within the baseband unit 1404. The baseband unit 1404 may be a component of the DU and may include the memory 376 and/or at least one of the TX processor 316, the RX processor 370, and the controller/processor 375.

The communication manager 1432 includes a support resource indication component 1440 that transmits, to a CU of the wireless network, an indication of one or more types of resources for which the DU supports admission, e.g., as described in connection with 1302 of FIG. 13. The communication manager 1432 further includes an admission request process component 1442 that receives, from the CU, a request for the admission of at least one resource having a type included in the one or more types of resources indicated to the CU, e.g., as described in connection with 1304 of FIG. 13.

The apparatus may include additional components that perform each of the blocks of the algorithm in the flowchart of FIG. 13. As such, each block in the flowchart of FIG. 13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1402 may include a variety of components configured for various functions. In one configuration, the apparatus 1402, and in particular the baseband unit 1404, includes means for transmitting, to a CU of the wireless network, an indication of one or more types of resources for which the DU supports admission (e.g., the support resource indication component 1440 and/or the transmission component 1434). The apparatus 1402 includes means for receiving, from the CU, a request for the admission of at least one resource having a type included in the one or more types of resources indicated to the CU (e.g., the admission request process component 1442 and/or the reception component 1430). The apparatus 1402 includes means for operating in an energy saving mode or below a full capacity and means for transmitting the indication based on operation in the energy saving mode or below the full capacity. The apparatus 1402 includes means for receiving, from the CU, a query for a list of resources in which the DU is capable to admit, and means for transmitting, to the CU, the indication based on the query (e.g., the support resource indication component 1440, the reception component 1430, and/or the transmission component 1434).

The means may be one or more of the components of the apparatus 1402 configured to perform the functions recited by the means. As described supra, the apparatus 1402 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication including a memory; at least one transceiver; and at least one processor communicatively connected to the memory and the at least one transceiver, the at least one processor configured to: receive, from a DU of the wireless network, an indication of one or more types of resources for which the DU supports admission; and transmit, to the DU, a request for the admission of at least one resource in response to the at least one resource having a type included in the one or more types of resources indicated by the DU.

Aspect 2 is the apparatus of aspect 1, where the indication is associated with an energy saving mode of the DU or operation below a full capacity of the DU.

Aspect 3 is the apparatus of aspect 1 or aspect 2, where the request for the admission of the at least one resource requests the DU to set up or modify a context for a UE.

Aspect 4 is the apparatus of any of aspects 1 to 3, where the request for the admission of the at least one resource requests the DU to set up or modify a traffic instance for a UE.

Aspect 5 is the apparatus of any of aspects 1 to 4, where the traffic instance includes at least one of: a DRB, an F1-U tunnel, a QoS flow, or a BH RLC CH.

Aspect 6 is the apparatus of any of aspects 1 to 5, where the request for the admission of the at least one resource requests the DU to allocate a communication resource for a UE.

Aspect 7 is the apparatus of any of aspects 1 to 6, where the communication resource includes at least one of: a time resource, a frequency resource, or a spatial resource.

Aspect 8 is the apparatus of any of aspects 1 to 7, where the one or more types of resources for which the DU supports the admission include a type of device to be served by the DU.

Aspect 9 is the apparatus of any of aspects 1 to 8, where the type of device includes at least one of: a UE, an IAB node, or a repeater that is served by the DU.

Aspect 10 is the apparatus of any of aspects 1 to 9, where the one or more types of resources for which the DU supports the admission is associated with at least one capability of a UE to be served by the DU.

Aspect 11 is the apparatus of any of aspects 1 to 10, where the at least one capability of the UE includes at least one of: a beam correspondence associated with beam sweeping, a processing time associated with receiving a PDSCH and sending a corresponding HARQ feedback, a support of CLI measurement and reporting, or a full or half duplex capability.

Aspect 12 is the apparatus of any of aspects 1 to 11, where the one or more types of resources for which the DU supports the admission include a traffic instance type to be configured at the DU.

Aspect 13 is the apparatus of any of aspects 1 to 12, where the traffic type includes at least one of: a non-GRB traffic, a GRB traffic, a delay-critical GBR traffic, or a TSC traffic.

Aspect 14 is the apparatus of any of aspects 1 to 13, where the one or more types of resources for which the DU supports the admission are associated with a condition on a QoS parameter for a traffic instance of a UE to be setup at the DU.

Aspect 15 is the apparatus of any of aspects 1 to 14, where the condition includes at least one of: a guaranteed flow bit rate below a bit rate threshold, or a packet delay budget above a delay budget threshold.

Aspect 16 is the apparatus of any of aspects 1 to 15, where the indication is associated with a UE.

Aspect 17 is the apparatus of any of aspects 1 to 16, where the indication is applicable to multiple UEs.

Aspect 18 is the apparatus of any of aspects 1 to 17, where the at least one processor is further configured to: forward the indication to a second CU; and receive a resource request from the second CU based on the indication forwarded to the second CU.

Aspect 19 is the apparatus of any of aspects 1 to 18, where the resource request includes at least one of: a handover request, or a secondary node addition request.

Aspect 20 is the apparatus of any of aspects 1 to 19, where the at least one processor is further configured to: receive a resource request from a second CU; and admit or reject the resource request based on the indication.

Aspect 21 is the apparatus of any of aspects 1 to 20, where the at least one processor is further configured to: transmit, to the DU, a query for a list of resources in which the DU is capable to admit; and receive, from the DU, the indication based on the query.

Aspect 22 is a method of wireless communication for implementing any of aspects 1 to 21.

Aspect 23 is an apparatus for wireless communication including means for implementing any of aspects 1 to 21.

Aspect 24 is a computer-readable medium storing computer executable code, where the code when executed by a processor causes the processor to implement any of aspects 1 to 21.

Aspect 25 is an apparatus for wireless communication including a memory; at least one transceiver; and at least one processor communicatively connected to the memory and the at least one transceiver, the at least one processor configured to: transmit, to a CU of the wireless network, an indication of one or more types of resources for which the DU supports admission; and receive, from the CU, a request for the admission of at least one resource having a type included in the one or more types of resources indicated to the CU.

Aspect 26 is the apparatus of aspect 25, where the at least one processor is further configured to: operate in an energy saving mode or below a full capacity and to transmit the indication based on operation in the energy saving mode or below the full capacity.

Aspect 27 is the apparatus of any of aspects 25 and 26, where the request for the admission of the at least one resource requests the DU to set up or modify a context for a UE.

Aspect 28 is the apparatus of any of aspects 25 to 27, where the request for the admission of the at least one resource requests the DU to set up or modify a traffic instance for a UE.

Aspect 29 is the apparatus of any of aspects 25 to 28, where the traffic instance includes at least one of: a DRB, an F1-U tunnel, a QoS flow, or a BH RLC CH.

Aspect 30 is the apparatus of any of aspects 25 to 29, where the request for the admission of the at least one resource requests the DU to allocate a communication resource for a UE.

Aspect 31 is the apparatus of any of aspects 25 to 30, where the communication resource includes at least one of: a time resource, a frequency resource, or a spatial resource.

Aspect 32 is the apparatus of any of aspects 25 to 31, where the one or more types of resources for which the DU supports the admission include a type of device to be served by the DU.

Aspect 33 is the apparatus of any of aspects 25 to 32, where the type of device includes at least one of: a UE, an IAB node, or a repeater that is served by the DU.

Aspect 34 is the apparatus of any of aspects 25 to 33, where the one or more types of resources for which the DU supports the admission is associated with at least one capability of a UE to be served by the DU.

Aspect 35 is the apparatus of any of aspects 25 to 34, where the at least one capability of the UE includes at least one of: a beam correspondence associated with beam sweeping, a processing time associated with receiving a PDSCH and sending a corresponding HARQ feedback, a support of CLI measurement and reporting, or a full or half duplex capability.

Aspect 36 is the apparatus of any of aspects 25 to 35, where the one or more types of resources for which the DU supports the admission include a traffic instance type to be configured at the DU.

Aspect 37 is the apparatus of any of aspects 25 to 36, where the traffic type includes at least one of: a non-GRB traffic, a GRB traffic, a delay-critical GBR traffic, or a TSC traffic.

Aspect 38 is the apparatus of any of aspects 25 to 37, where the one or more types of resources for which the DU supports the admission are associated with a condition on a QoS parameter for a traffic instance of a UE to be setup at the DU.

Aspect 39 is the apparatus of any of aspects 25 to 38, where the condition includes at least one of: a guaranteed flow bit rate below a bit rate threshold, or a packet delay budget above a delay budget threshold.

Aspect 40 is the apparatus of any of aspects 25 to 39, where the indication is associated with a UE.

Aspect 41 is the apparatus of any of aspects 25 to 40, where the indication is applicable to multiple UEs.

Aspect 42 is the apparatus of any of aspects 25 to 41, where the at least one processor is further configured to: receive, from the CU, a query for a list of resources in which the DU is capable to admit; and transmit, to the CU, the indication based on the query.

Aspect 43 is a method of wireless communication for implementing any of aspects 25 to 42.

Aspect 44 is an apparatus for wireless communication including means for implementing any of aspects 25 to 42.

Aspect 45 is a computer-readable medium storing computer executable code, where the code when executed by a processor causes the processor to implement any of aspects 25 to 42.

What is claimed is:

1. An apparatus for wireless communication at a central unit (CU) of a wireless network, comprising:
a memory; and
at least one processor communicatively connected to the memory, the at least one processor configured to:
receive, from a distributed unit (DU) of the wireless network, an indication of one or more types of resources for which the DU supports admission; and
transmit, to the DU, a request for the admission of at least one resource in response to the at least one resource having a type included in the one or more types of resources indicated by the DU.

2. The apparatus of claim 1, wherein the apparatus further includes:
a transceiver coupled to the at least one processor, and wherein the indication is associated with an energy saving mode of the DU or operation below a full capacity of the DU.

3. The apparatus of claim 1, wherein the request for the admission of the at least one resource requests the DU to setup or modify a context for a user equipment (UE).

4. The apparatus of claim 1, wherein the request for the admission of the at least one resource requests the DU to setup or modify a traffic instance for a user equipment (UE).

5. The apparatus of claim 1, wherein the request for the admission of the at least one resource requests the DU to allocate a communication resource for a user equipment (UE).

6. The apparatus of claim 1, wherein the one or more types of resources for which the DU supports the admission include a device type to be served by the DU.

7. The apparatus of claim 1, wherein the one or more types of resources for which the DU supports the admission is associated with at least one capability of a user equipment (UE) to be served by the DU.

8. The apparatus of claim 1, wherein the one or more types of resources for which the DU supports the admission include a traffic instance type to be configured at the DU.

9. The apparatus of claim 1, wherein the one or more types of resources for which the DU supports the admission are associated with a condition on a quality of service (QoS) parameter for a traffic instance of a user equipment (UE) to be setup at the DU.

10. The apparatus of claim 1, wherein the indication is associated with a user equipment (UE).

11. The apparatus of claim 1, wherein the indication is applicable to multiple user equipments (UEs).

12. The apparatus of claim 1, wherein the at least one processor is further configured to:
forward the indication to a second CU; and
receive a resource request from the second CU based on the indication forwarded to the second CU.

13. The apparatus of claim 12, wherein the resource request includes at least one of:
a handover (HO) request, or a secondary node (SN) addition request.

14. The apparatus of claim 1, wherein the at least one processor is further configured to:
receive a resource request from a second CU; and
admit or reject the resource request based on the indication.

15. The apparatus of claim 1, wherein the at least one processor is further configured to:
transmit, to the DU, a query for a list of resources in which the DU is capable to admit; and
receive, from the DU, the indication based on the query.

16. A method of wireless communication at a central unit (CU) of a wireless network, comprising:
receiving, from a distributed unit (DU) of the wireless network, an indication of one or more types of resources for which the DU supports admission; and
transmitting, to the DU, a request for the admission of at least one resource in response to the at least one resource having a type included in the one or more types of resources indicated by the DU.

17. An apparatus for wireless communication at a distributed unit (DU) of a wireless network, comprising:
a memory; and
at least one processor communicatively connected to the memory, the at least one processor configured to:
transmit, to a central unit (CU) of the wireless network, an indication of one or more types of resources for which the DU supports admission; and
receive, from the CU, a request for the admission of at least one resource having a type included in the one or more types of resources indicated to the CU.

18. The apparatus of claim 17, the apparatus further includes:
a transceiver coupled to the at least one processor, and wherein the at least one processor is further configured to:
operate in an energy saving mode or below a full capacity and to transmit the indication based on operation in the energy saving mode or below the full capacity.

19. The apparatus of claim 17, wherein the request for the admission of the at least one resource requests the DU to setup or modify a context for a user equipment (UE).

20. The apparatus of claim 17, wherein the request for the admission of the at least one resource requests the DU to setup or modify a traffic instance for a user equipment (UE).

21. The apparatus of claim 17, wherein the request for the admission of the at least one resource requests the DU to allocate a communication resource for a user equipment (UE).

22. The apparatus of claim 17, wherein the one or more types of resources for which the DU supports the admission include a device type to be served by the DU.

23. The apparatus of claim 17, wherein the one or more types of resources for which the DU supports the admission is associated with at least one capability of a user equipment (UE) to be served by the DU.

24. The apparatus of claim 17, wherein the one or more types of resources for which the DU supports the admission include a traffic instance type to be configured at the DU.

25. The apparatus of claim 17, wherein the one or more types of resources for which the DU supports the admission are associated with a condition on a quality of service (QoS) parameter for a traffic instance of a user equipment (UE) to be setup at the DU.

26. The apparatus of claim 25, wherein the condition includes at least one of: a guaranteed flow bit rate below a bit rate threshold, or a packet delay budget above a delay budget threshold.

27. The apparatus of claim 17, wherein the indication is associated with a user equipment (UE).

28. The apparatus of claim 17, wherein the indication is applicable to multiple user equipments (UEs).

29. The apparatus of claim 17, wherein the at least one processor is further configured to:
receive, from the CU, a query for a list of resources in which the DU is capable to admit; and
transmit, to the CU, the indication based on the query.

30. A method of wireless communication at a distributed unit (DU) of a wireless network, comprising:
transmitting, to a central unit (CU) of the wireless network, an indication of one or more types of resources for which the DU supports admission; and
receiving, from the CU, a request for the admission of at least one resource having a type included in the one or more types of resources indicated to the CU.
